(19) United States
(12) Patent Application Publication
(10) Pub. No.: US 2012/0264072 A1
(43) Pub. Date: Oct. 18, 2012

(54) METHOD AND APPARATUS FOR PERFORMING REACTIVE THERMAL TREATMENT OF THIN FILM PV MATERIAL

(75) Inventor: Ashish Tandon, Sunnyvale, CA (US)

(73) Assignee: Stion Corporation, San Jose, CA (US)

(21) Appl. No.: 13/352,574

(22) Filed: Jan. 18, 2012

Related U.S. Application Data
(60) Provisional application No. 61/439,079, filed on Feb. 3, 2011.

(51) Int. Cl. F27D 19/00; F27B 9/12; F27D 15/02; F27B 5/06; F27B 5/16

(52) U.S. Cl. 432/18; 432/253; 432/200; 432/51; 432/81; 432/23; 432/24

(57) ABSTRACT

An apparatus for performing reactive thermal treatment of thin film photovoltaic devices includes a furnace having a tubular body surrounded by heaters and cooling devices. The apparatus includes cooled doors at ends of the furnace separated from a central portion of the furnace by baffles. The cooled doors facilitate increased convection within the furnace and improve temperature uniformity.

### CROSS-REFERENCES TO RELATED APPLICATIONS

This application claims the benefit of U.S. Provisional Application No. 61/439,079, filed Feb. 3, 2011, entitled “Method and Apparatus for Performing Reactive Thermal Treatment of Thin Film PV Material.” The entire disclosure of which is incorporated herein.

### BACKGROUND OF THE INVENTION

This invention relates to photovoltaic materials and manufacturing methods. More particularly, the invention provides a method and apparatus for performing reactive thermal treatment of thin film photovoltaic materials, and provides a method and apparatus for improving temperature uniformity and reducing process time during reactive thermal processes.

Energy comes in forms such as petrochemical, hydroelectric, nuclear, wind, biomass, solar, and more primitive forms such as wood and coal. Over the past century, modern civilization has relied upon petrochemical energy as an important energy source. Petrochemical energy includes gas and oil. Gas includes lighter forms such as butane and propane, commonly used to heat homes and serve as fuel for cooking Gas also includes gasoline, diesel, and jet fuel, commonly used for transportation purposes. Heavier forms of petrochemicals can also be used to heat homes in some places.

More recently, environmentally clean and renewable energy sources are desired. One type of clean energy is solar energy. Solar energy technology generally converts electromagnetic radiation from the sun to other forms of energy. Although solar energy is environmentally clean and has been successful to a point, many limitations remain to be overcome before it becomes widely used throughout the world. As an example, one type of solar cell uses crystalline materials derived from semiconductor material. These crystalline materials can be used to fabricate optoelectronic devices that include photovoltaic and photodiode devices that convert electromagnetic radiation to electrical power. Crystalline materials, however, are costly and difficult to make on a large scale; and devices made from such crystalline materials have low energy conversion efficiencies. Other types of solar cells use “thin film” technology to form a thin film of photosensitive material to be used to convert electromagnetic radiation into electrical power. Similar limitations exist with the use of thin film technology. Additionally, film reliability is often poor and cannot be used for extensive periods of time in conventional environmental applications. Thin films are often difficult to mechanically integrate with each other.

As an effort to improve thin film solar cell technology, processes of manufacturing an advanced CIS and/or CIGS based photovoltaic film stack on substrates with planar, tubular, cylindrical, circular or other shapes have been developed. There are various manufacturing challenges in forming the photovoltaic film stack, such as maintaining structure integrity of substrate materials, controlling chemical compositions of the ingredients in one or more precursor layers, carrying out proper thermal treatment of the one or more precursor layers within a reactive gaseous environment, ensuring uniformity and granularity of the thin film material on substrates during reactive thermal treatment, etc. Especially, when manufacturing the thin film based photovoltaic device on large sized substrates, temperature uniformity across the whole substrate surface is desired. It is desirable to have an improved system and method for processing thin film photovoltaic devices on planar or non-planar shaped, fixed or flexible substrates.

### BRIEF SUMMARY OF THE INVENTION

This invention provides a method and apparatus for thermal treatment of thin film solar cells with improved temperature uniformity and reduced process time. The method and apparatus provide a dual door cover for enhancing both conduction and convection cooling and substrate temperature uniformity during reactive thermal treatment processes. The invention provides an apparatus for performing reactive thermal treatment of thin film photovoltaic devices. The apparatus includes a furnace having a tubular body surrounded by heaters and cooling devices. The tubular body encloses an interior volume from a first end to a second end. A first door structure covers the first end with a first plate facing the interior volume. The first plate is coupled to a first coil pipe within the door structure. A similar structure is provided at the opposite end of the furnace. In addition, the apparatus includes a removable rack fixture within the furnace. The rack fixture allows an array of substrates to be loaded into the interior volume from either end of the furnace. Baffle members disposed in the interior volume control interior convection.

Preferably, the furnace is made of quartz which is substantially chemically inert and has good thermal conductivity characteristics. The substrates, each having a dimension ranging from about 20 cm to 156 cm, are loaded using the rack fixture. The large industrial thin-film substrates are maintained at one process temperatures for annealing in an reactive gaseous environment. Combined effects of thermal conduction through the quartz body and controlled convection induced by the door structures result in a temperature variation typically no more than 10° C. during the process period, across the substrates of as large as 156 cm and greater.

In an alternative embodiment of the present invention, a method for performing a reactive thermal treatment of photovoltaic material with enhanced temperature uniformity is provided. The method includes providing a furnace enclosing a tubular volume between a first end cover and a second end cover for holding one or more substrates therein. The furnace is then heated to a process temperature range, and held with a variation less than 10 degrees Centigrade for performing a reactive thermal treatment of the substrates. The furnace is then cooled to reduce the temperature of the substrates from the process temperature range to near room temperature, at a rate of about 1 degree per minute or faster.

The method provides reactive thermal treatment of a thin-film precursor to form an absorber of photovoltaic devices on large glass substrates. The apparatus for performing the thermal treatment in a reactive gaseous environment preferably requires the furnace itself to be chemically inert and thermally conductive. In a specific embodiment, the apparatus is a quartz tube with end covers for facilitating convection of working gases therein. Baffle members are used to retain the working gases around the substrates as necessary. The end covers are symmetrical disposed with built-in heat-exchanger structures to keep a cool plate to serve as both cold traps for residue particles and heat sinks Thus the large substrates can be placed in the furnace tube and maintained at a process temperature range with high temperature uniformity. This enables the reaction between the working gases and the precursor material on the substrates to be performed with improved temperature uniformity, leading to formation of a photovoltaic absorber with higher conversion efficiency.

### BRIEF DESCRIPTION OF THE DRAWINGS

FIG. 1 is a cross-sectional view of an apparatus for processing thin-film photovoltaic materials on large panel substrates;

FIG. 2 is a cross-sectional view illustrating baffle members for convection control;

FIG. 3 is a simplified diagram illustrating a method for performing reactive thermal treatment of photovoltaic devices; and

FIG. 4 is an exemplary plot illustrating a temperature profile for processing the substrates.

### DETAILED DESCRIPTION OF THE INVENTION

This invention provides a method and apparatus for processing thin film solar cells on substrates with improved temperature uniformity. The method and structure are applied for the manufacture of copper indium gallium selenide thin film photovoltaic devices on glass substrates, but the invention can be used in other processes.

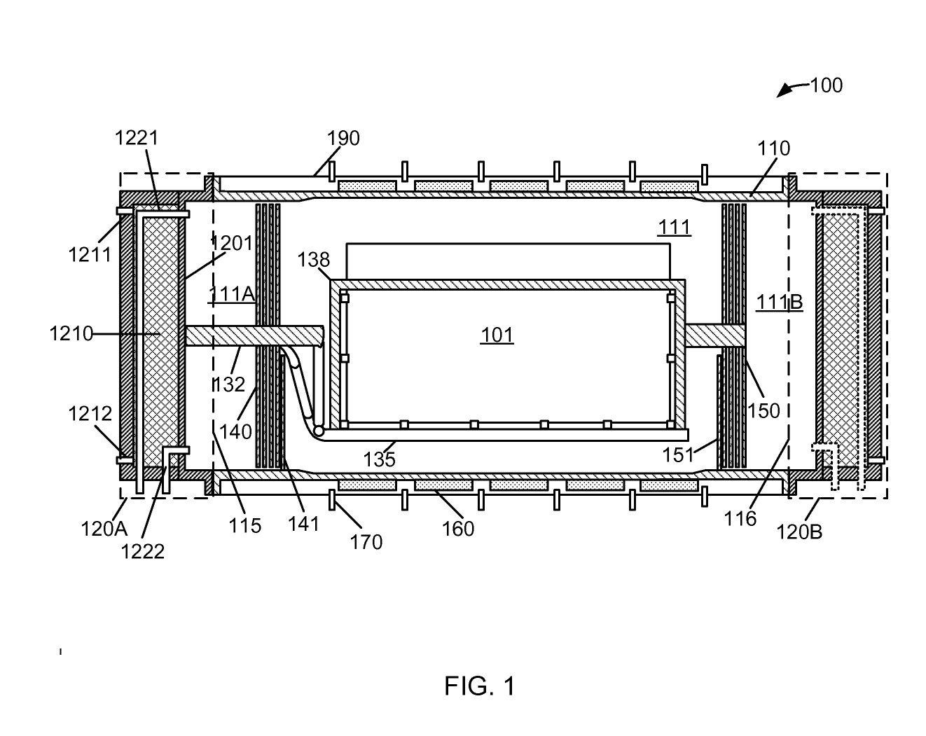

FIG. 1 is a cross-sectional view of an embodiment of apparatus for processing thin-film photovoltaic materials on large panel substrates. As shown, a process chamber 100 for performing thermal treatment is illustrated in a cross-sectional view cut along a central plane from a first end region 115 to a second end region 116. The chamber 100 is a tubular shaped furnace enclosing an interior volume 111. The width of the rectangle in FIG. 1 is a diameter of the tubular shaped furnace. The tubular body 110 is surrounded by heating elements 160 and cooling elements 170, both installed with a shell structure 190. The heating elements 160 can be resistive heating tapes or pipes with appropriate fluid.

The tubular body 110 preferably is a material having good thermal conductivity, with heating elements 160 in contact with the tubular body 110 so that thermal energy can be directly conducted into the furnace. For example, the chamber 100 can be quartz, which is resistive to reactive gases and a good thermal conductor. Other techniques can be used to heat the quartz tubular body. In addition, the cooling elements may be provided by a refrigerant gas flowing around the outside of the quartz tubular body. This allows the temperature of the furnace chamber 100 to be controlled as necessary for the thermal processing.

In FIG. 1 the chamber 100 includes two end covers (or door structures) 120A and 120B respectively configured to cover a first end 115 and a second end 116. Each of the end covers 120A or 120B includes a plate 1201 facing inside of the furnace and an interior coil structure 1210 coupled to the plate 1201. In an embodiment, the end cover is a conventional metal used in vacuum systems, e.g. stainless steel, aluminum, and the like. The coiled pipe structure 1210 provides a heat exchanger capable of circulating fluid coolant from an inlet 1211 to an outlet 1212. The plate 1201 can be cooled as desired by using running water coolant.

The two end covers 120A and 120B are designed to seal the chamber 100 to form a vacuum system. Either of the end cover 120A or 120B can also include vacuum pipes—one pipe 1221 for supplying desired gas species into the chamber interior volume 111 from an external source and one pipe 1222 connected to a vacuum pump to empty the chamber before a process or purge the chamber after a process. In a process, the work gases include selenide gas or sulfide gas, often mixed with inert gases as carrier gas. The selenium and sulfur species are commonly used for forming thin-film photovoltaic materials in a reactive thermal treatment process.

The furnace chamber 100 is designated for performing thermal treatment of thin-film materials on substrates. Substrates can be loaded from either the first end region 115 or the second end region 116 by opening the corresponding door structure or end cover 120A or 120B. The substrates 101 can be loaded in a boat structure 138 which is inserted into the interior volume 111 of the furnace chamber. The substrates 101 are usually large panels of glass or other material designated for forming thin-film photovoltaic devices thereon. Typically the substrates are rectangular shaped glass substrates having a dimension as large as 156 cm. Each substrate has usually been preprocessed to form films stacks overlying the glass surface. A thin-film precursor material such as a copper species, an indium species, a gallium species, and/or sodium dopants mixed by various depositing or doping techniques, can be formed on top of the film stacks. In one embodiment, the copper-indium-gallium mixed precursor is intended for reacting with selenium or sulfur gaseous species to form a thin-film photovoltaic absorber. The boat structure 138, loaded with the substrates 101, is supported by a rack fixture 135 inside the chamber. In an embodiment, the rack fixture 135 is a removable via the door structures using a shaft 132. In another embodiment, the rack fixture 135 is loaded and unloaded by a robot loader (not shown) associated the apparatus 100. The rack fixture 135 and boat structure 138 inside the interior volume are exposed to the reactive work gases, so they each are preferably chemically inert. In an implementation, all are quartz material.

The furnace chamber 100 can also includes baffles near the ends 115 and 116. These baffle members assist in keeping heated gases within the interior volume where the substrates are treated while keeping cooler gases in regions 111A and 111B near the end covers. The baffles include a first group of baffles 140 substantially covering a major portion of the cross section area of the tubular body and a baffle 141 covering the lower edge portion. The baffles 140 are disk shaped and positioned near the middle part of tubular interior volume. The baffle 141 is crescent shaped to partially cover the lower edge portion of the disk baffles. Near the other end 116, a group of disk shape baffles 150 cover of the tube cross-section and a crescent baffle 151 is attached to the tubular furnace body. All these baffles can be quartz.

As used herein, “crescent” means a “shape produced when a circular disk has a segment of another circle removed from its edge, so that what remains is a shape enclosed by two circular arcs of different diameters which intersect at two points.” For example, some descriptions or definitions can be found in public information website such as http://en.wikipedia.org/wiki/Crescent.

The substrates are usually planar shaped, e.g. like a panel of glass. Typical sizes are a 20×20 cm glass square, a 20×50 cm glass rectangle, a 65×156 cm glass rectangle. The glass is usually soda lime glass, widely used for substrates of solar cells. Of course the substrate can be made of other materials including fused silica, quartz, or others. The substrates can be other planar shapes, including rectangular, square, disk, as well as non-planar shapes such as a rod, tube, semi-cylindrical tile, or even flexible foil, depending on applications.

The substrates usually have overlayers formed by earlier processes. For example, a precursor layer including a copper species, an indium species, and/or an indium-gallium species may be formed on a surface of the substrate using sputtering techniques. In a subsequent reactive thermal treatment process, the precursor layer is reactively treated in a gaseous environment within the furnace tube containing a selenide species, or a sulfide species, and a nitrogen species. When the furnace tube is heated, the gaseous selenium reacts with the copper-indium-gallium species in the precursor layer. As a result of the reactive thermal treatment, the precursor layer is transformed to a photovoltaic film stack containing copper indium (gallium) diselenide (CIGS) compound, which is a p-type semiconductor and serves as an absorber layer for forming photovoltaic cells. Further description of the thermal treatment process for forming the CIGS photovoltaic film stack of thin film solar cells is found in U.S. Patent Application Ser. No. 61/178,459 entitled “Method and System for Selenization in Fabricating CIGS/CIS Solar Cells” filed on May 14, 2009, by Robert Wieting, assigned to Stion Corporation of San Jose and hereby incorporated by reference.

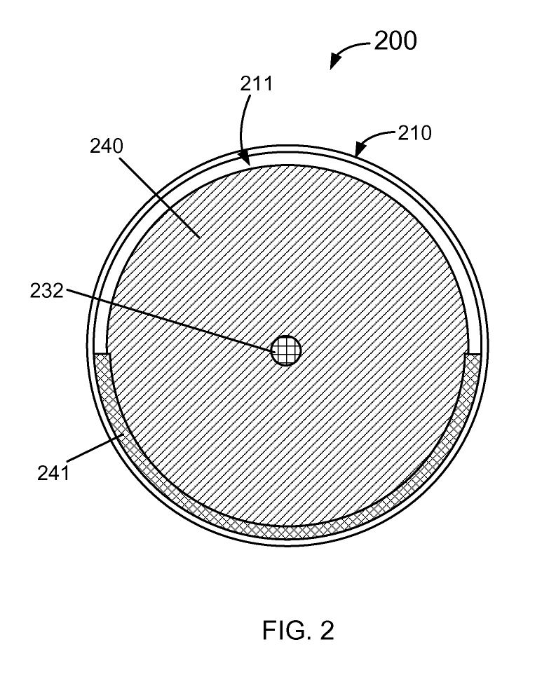

FIG. 2 is a cross-sectional view illustrating baffle members for convection control according to an embodiment of the present invention. The furnace tube 210, substantially the same as the furnace structure 100, is shown in cross section perpendicular to the tube axis. A disk shaped baffle 240 is installed via a central shaft 232 (which can be coupled to an end cover 120A or 120B and the rack fixture 135). There can be more than one disk shaped baffle 240 disposed in parallel, although only one is visible. The disk shaped baffle 240 covers a major portion of the cross-section area. Baffle 240 provides control of the internal thermal transfer by retaining heated work gases in central region 111 of the furnace where the substrates are positioned. Each baffle 240 helps block thermal radiation loss. With four baffles 240 disposed in parallel, with a gap between each, more than 98% heat loss by radiation is eliminated, thereby improving temperature uniformity within the central region of the interior volume.

In another embodiment, each disk shaped baffle 240 has a ring-shaped gap 211 between its peripheral rim and an inner wall of the furnace tube 210. This gap 211 allows a convection flow of the work gases from the central region 111 to the end cover region 111A (see FIG. 1) in a controlled manner. Because the gas temperature at the central region 111 is relative high and the end cover (e.g., 120A) is relatively cool, the hotter gas tends to flow upward, establishing a flow from the central region 111 over the upper portion of the gap 211 to the colder region 111A and back through the lower portion of the gap 211. In one embodiment, a crescent shaped baffle 241 is installed to contact the lower portion of the inner wall with at least one of the disk shaped baffles 240. In this configuration, shown in FIG. 2, the crescent shaped baffle 241 has an arc shape, and has the same curvature as the inner wall of the furnace tube 210. When the contact between the crescent baffle 241 and one disk shaped baffle 240 is provided, the height of the crescent shaped baffle 241 blocks the lower portion of the gap 211. As a result, the convection current through the lower portion of the gap 211 is blocked so that overall interior convection is altered. Although FIG. 2 shows a symmetric circular furnace tube, other geometric structures with symmetric and or even non-symmetric arrangement of the shaped baffles can be utilized depending on the embodiment.

Substrates are loaded in a boat structure supported on a rack fixture within the interior volume of the furnace tube. Usually each substrate is arranged vertically and in parallel to other substrates to facilitate work gas circulation. As shown in FIG. 1, the disk shaped baffles near both end covers divide the interior volume into a central region 111 and two end regions 111A and 111B. The furnace tube is heated by the heating element, particularly in central region 111, so that the substrates are thermally treated. As temperatures of substrates and work gases within central region increase, the work gases between the substrates flow, particularly upward. The end cover plates can be kept cool for processing purposes. Also the disk shaped baffles 240 provide a thermal radiation shield between the two regions. This creates a temperature drop across the baffles. The temperature drop from central region to end cover region, as well as the gap between the peripheral edges of the disk shaped baffles 240 and the circular inner wall of the furnace tube, allow convection currents flowing between the central region 111 and the ends. The relatively hotter gases flow through upper portions of the gap towards the end cover plate, where they are cooled to flow back mainly through lower portion of the gap.

During temperature ramping stage and a treatment stage at the processing temperature, the cool convection current is restricted so that the temperature around the substrate is more uniform. By optionally providing crescent shaped baffle 241, the lower portion of the gap, which is a major path for the cooled gases, is substantially blocked. The cooled gases are largely maintained in the end cover region, but may pass through the gap at the higher portion above the crescent shaped baffle gap, where the gases become warmer. In one embodiment, the arc length of the baffle 241 is one half of the perimeter of the furnace tube or smaller, e.g. 40% of the perimeter or smaller, however, it can be 50% to 66% of the perimeter, or larger, depending on the application. By reducing convection, the heated gases remain in the central region, accelerating heating operations.

During a temperature cooling stage (usually after the processing stage), however, an enhanced convection current flow is desired. Cooling of the furnace tube is achieved by first cooling the tubular body via thermal conduction, and secondly cooling the work gases inside furnace via interior convection with enhanced heat exchange between the work gases and the end cover plates. Cooling can be achieved by use of cooling elements 170 (see FIG. 1) around the tubular body 110. For example, cooling element 170 is a gas distributor capable of supplying a cold gas to the outer shell of the furnace tube to cool the tubular body 110. The cooled furnace body leads to cooling of work gases and the substrates inside. In addition, the face plates on the end covers 120A, 120B can be cooled by applying the refrigerant fluid through the coil pipes within the door structures, which pipes are connected to an external heater exchanger.

Another way of cooling is achieved by enhancing the convection current flow to move the warmer work gases within the central region faster towards the cooler face plates, and then back to the central region. Therefore, optionally, the crescent shaped baffle may be moved to re-open the lower portion of the gap. Of course, other approaches can be used to alter the convection to enhance the cooling. Using two door structures makes a symmetric configuration relative to the loaded substrates, and helps enhance temperature uniformity across the substrates in addition to obtaining a faster cooling rate.

In another embodiment, the cold face plate serves as a cold trap for absorbing un-reacted residue particles formed during the reactive thermal treatment processes. In such an example, the work gases include hydrogen selenide gas or hydrogen sulfide gas. When the temperature is increased to about the processing temperature range of 420° C., the hydrogen selenide gas can be subjected to thermal cracking and break into hydrogen gas and selenium particles. A portion of the Se particles may not complete a reaction with the precursor material on the substrate and are thus carried by the flow of work gases. Other gases or particles may be released from the substrate surfaces or precursor material mixtures as well, including un-reactive particles. An undesirable fate for these particles is to deposit onto the substrate surface, causing degradation of the photovoltaic absorber. By being kept cool during the process dwelling stage, the face plates of the end covers become major absorbing places for such un-reactive particles.

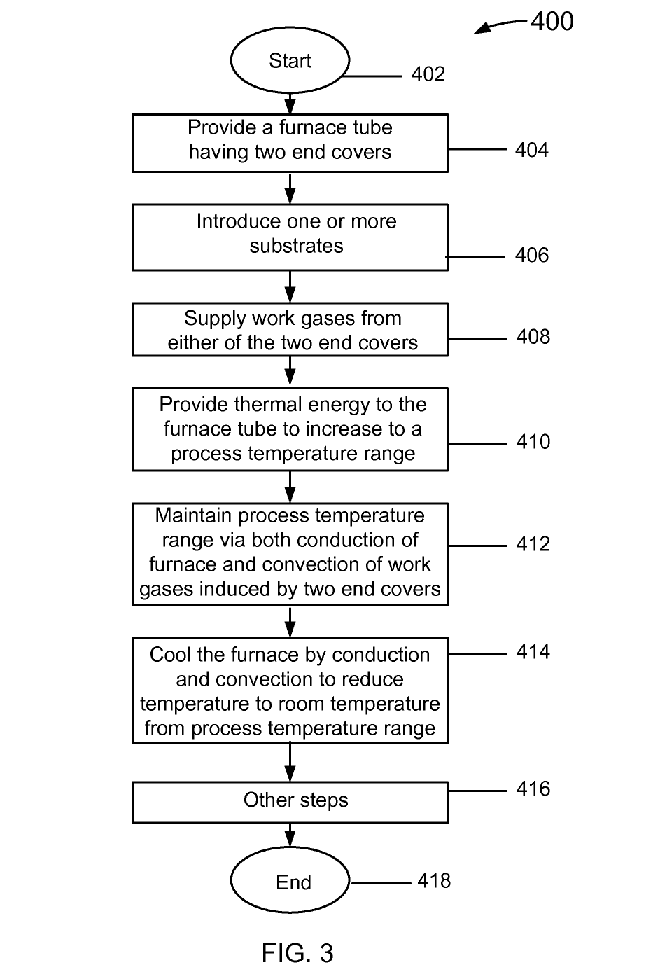

FIG. 3 is a diagram illustrating a method for performing reactive thermal treatment of photovoltaic devices. The steps of the method are:
1. Start;
2. Provide a furnace tube having two end covers;
3. Introduce substrates in the furnace tube and seal the end covers;
4. Supply work gas from either of the two end covers;
5. Increase the temperature to a process temperature range;
6. Maintain the process temperature range via both conduction of furnace and convection of work gases induced by the end covers;
7. Cool the furnace by conduction and convection to reduce temperature to room temperature;
8. Perform other steps;
9. End.

As shown, the above method provides an improved technique of treating a thin-film photovoltaic material in a reactive gas environment. In a preferred embodiment, the method uses a quartz furnace tube with end covers to provide stable heating and cooling, yet allow ramping of temperatures with faster rates by controlling both thermal conduction and internal convection. The two end covers can be kept cool, providing a cold trap for residue particles, and a heat exchange plate to induce healthy internal convection.

As shown, the method 400 for treating photovoltaic materials in a reactive thermal process starts with a step 402, which include preparing substrates with a thin-film precursor material. The thin-film precursor material includes a mixture of copper species, indium species, or gallium species, and sometimes sodium species. The method 400 follows with a step 404 providing a furnace tube as a processing apparatus. Substrates are then loaded (step 406), and the end covers seal the furnace. Usually the substrates are loaded into a substrate holder (or boat structure), and then the substrate holder is inserted into the furnace tube supported by a rack fixture. The substrate loading process can also be used to install baffles for altering internal convection as needed.

After the furnace is sealed, the method 400 includes a step 408 of supplying work gases via pipes through the end covers. In step 408 the method 400 provides a gaseous environment in the interior volume of the furnace tube ready for conducting reactive thermal treatment processes having a predetermined temperature profile. The work gases are supplied to the furnace tube from a gas supply device, such as a valve or injector coupled to the end covers of the furnace tube. The working gases usually include a chemical precursor species designed to react with the thin-film precursor material overlying the substrate. The working gases can include a carrier gas such as nitrogen, helium, argon, and other gases. Of course, the gas step usually is preceded with a purge process, either for preparing a vacuum before introducing the work gases, or purging the furnace after the process ends.

The method 400 includes a step 410 to increase temperature of the substrates. Following the ramping stage, the method 400 includes step 412 for maintaining the process temperature by controlling thermal transfer via both conduction and convection, as described above.

Method 400 next includes step 414 for cooling the furnace by conduction and convection to reduce temperature from the process temperature range to near room temperature. In an example, the substrate can be cooled in a rate of 1 degree per minute, or 3 degrees per minute or faster, while still keep a reasonably uniform temperature across the large substrate.

Subsequently, other steps 416 may be followed to purge the chamber with nitrogen gas and remove all the reactive gases, to handle the treated substrates for continuing other processes for manufacturing a photovoltaic device on the large sized substrate according to an embodiment of the present invention.

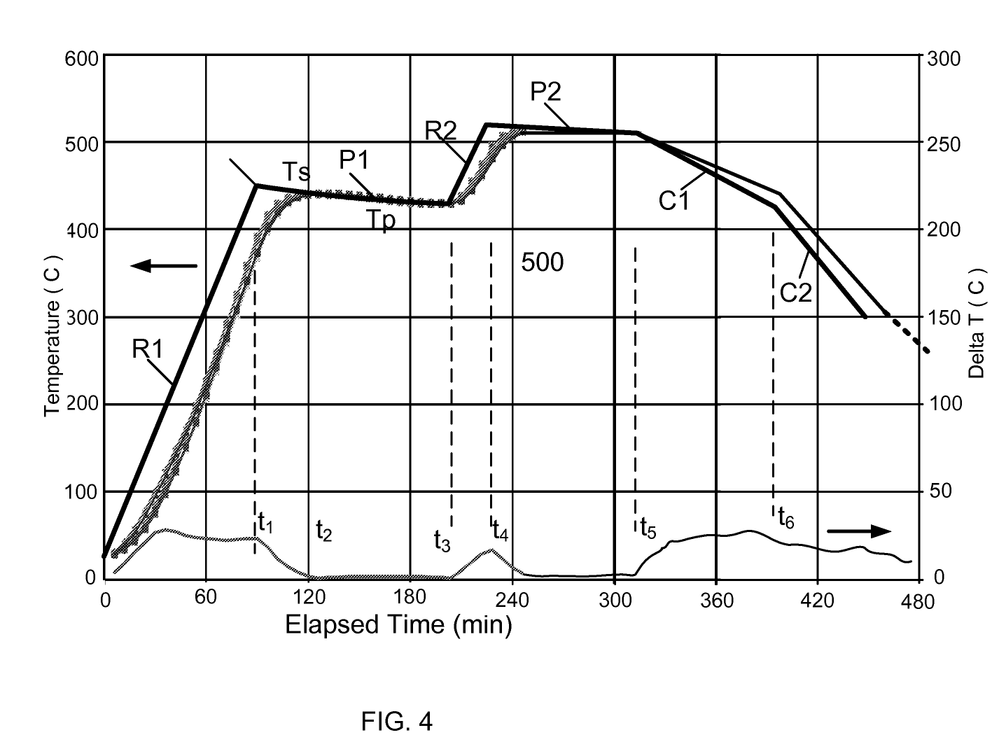

FIG. 4 is a diagram illustrating a temperature profile in a furnace tube according to an embodiment of the present invention. The temperature profile 500 is illustrated as a plot of substrate temperature as a function of elapsed time. The maximum temperature variation across substrates is also plotted in the same diagram. The temperature profile includes a first temperature ramp stage R1 to increase temperature of the heating elements from room temperature to a predetermined set point Ts. Then first process stage P1 is started so that the substrate temperature approaches the process temperature range. For example, the first ramp stage reaches the set point at a time t1, after which the substrate temperatures are increased to the first process temperature range Tp of about 425° C. at t2. The thermal treatment process, with substrate temperature maintained substantially at Tp, lasts until time t3. Then a second ramp stage R2 pushes the temperature higher to reach a second process stage P2 at time t4. During P2, substrates are subjected to further thermal treatment at this second process temperature, e.g., about 510° C., until time t5 to finish the reactive annealing process for forming photovoltaic absorber material. In an embodiment, the ramp stages R1 and R2 are executed at a rate of about 4-5 degrees per minute. The furnace performs this ramp stage while maintaining the temperature variation less than 40° C. across the substrates. Thus the substrates, for example, glass material, are subjected to lower thermal stress.

After the stage P2, the process requires a first cooling stage C1. The first cooling process is preferred to be carried out with a relatively slow cooling rate. With a cooling rate of about a half degree drop per minute, or slower, the glass maintains sufficient viscosity to relax internal stress up to time t6, when the temperature reaches about 430° C. Beyond this point, the glass will not have much retained strain, so a further drop in temperature would not cause damage. Then, an accelerate cooling stage C2 is started, with cooling of 1 to 3 degrees per minute. This enhanced cooling rate can substantially reduce process time and increase productivity.

While the present invention has been described using specific embodiments, it should be understood that various changes, modifications, and variations may be effected without departing from the spirit and scope of the invention as defined in the appended claims. For example, while a tubular shaped furnace is illustrated, other shapes of furnace and baffles can be used. Additionally, although the above embodiments are applied to reactive thermal treatment for forming CIS and/or CIGS photovoltaic devices, other thermal processes can also be used.

What is claimed is:

1. An apparatus for performing reactive thermal treatment of thin film photovoltaic devices, the apparatus comprising:
a furnace having a body and associated heating and cooling devices, the body enclosing an interior volume from a first end to a second end;
a first door structure configured to cover the first end with a first plate facing the interior volume, the first plate being coupled to a first coil pipe within the first door structure;
a second door structure configured to cover the second end with a second plate facing the interior volume, the second plate being coupled to a second coil pipe within the second door structure;
a rack fixture disposed within the furnace, the rack fixture capable of supporting an array of substrates in the interior volume; and
a first plurality of baffle members disposed in vicinity of the first plate and a second plurality of baffle members disposed in vicinity of the second plate, the first plurality of baffle members and second plurality of baffle members controlling interior convection within the interior volume.

2. The apparatus of claim 1 wherein the body comprises a tubular body.

3. The apparatus of claim 2 wherein the first plurality of baffle members and the second plurality of baffle members comprise disk shaped baffle members coupled to the rack fixture.

4. The apparatus of claim 3 further including crescent shaped baffle members having a width and an arc length greater than a half perimeter of the tubular body, and being disposed on a lower half of the tubular body near the first end and the second end.

5. The apparatus of claim 3 wherein the disk shaped baffle members have a diameter smaller than that of an interior diameter of the tubular body, thereby providing a gap around peripheral edges of the disk shaped baffle members, the gap at a lower portion of the tubular body being blocked by the crescent shaped baffle members.

6. The apparatus of claim 1 further comprising:
a gas inlet coupled to at least one of the first door structure and the second door structure, the gas inlet being used to introduce work gases into the interior volume at least through the gap; and
the gas outlet being connected to a pump to enable purging the furnace.

7. The apparatus of claim 6 wherein the associated heating and cooling devices provide a controlled thermal energy transfer to the interior volume.

8. The apparatus of claim 7 wherein the furnace is controlled to provide a temperature profile having a ramping stage to increase temperature from room temperature to a process temperature at a first rate, a dwelling stage holding the process temperature above room temperature for an annealing time, and a cooling stage to decrease temperature from the process temperature at a second rate.

9. The apparatus of claim 8 wherein the first plate and the second plate are each connected to receive a fluid coolant from an external heat exchanger, and also to absorb un-reacted particles.

10. The apparatus of claim 8 wherein the first plate and the second plate are both cooled to enable an array of substrates in the interior volume to be maintained at the process temperature with a temperature variation of less than 10 degrees Centigrade during the dwelling stage.

11. The apparatus of claim 9 wherein the first plate and the second plate are both metal and cooled to substantially room temperature.

12. The apparatus of claim 1 wherein the furnace is capable of containing an array of glass substrates having at least one dimension no greater than 165 cm.

13. A method for performing a reactive thermal treatment of photovoltaic material, the method comprising:
providing a furnace enclosing a volume between a first end cover and a second end cover;
introducing at least one substrate into the volume;
supplying a work gas into the volume;
increasing the temperature of the work gas and the at least one substrate to a process temperature;
maintaining the process temperature with a variation less than 10 degrees Centigrade to perform a thermal treatment of the at least one substrate with the work gas; and
cooling the furnace by conduction and convection to reduce the temperature of the at least one substrate from the process temperature to near room temperature at a rate of at least 1 degree per minute.

14. The method of claim 13 wherein the furnace comprises a quartz tube with a length of at least about 2 meters and a diameter of at least about 1 meter, the quartz tube having at least one heating element s and at least one cooling element in proximity to the tube.

15. The method of claim 13 wherein the at least one substrate comprises a glass plate with an overlying thin-film precursor comprising at least one of a copper, an indium, and a gallium species.

16. The method of claim 13 wherein the work gas comprises at least one of selenide gas, sulfide gas, and nitrogen gas.

17. The method of claim 14 wherein the step of increasing the temperature of the work gas comprises using conduction and convection.

18. The method of claim 14 wherein the step of maintaining the process temperature comprises:
positioning heating elements in proximity to the furnace;
introducing a plurality of baffles to control convection flow, near both the first end cover and the second end cover, and
maintaining the first end cover and the second end cover at a lower temperature than a central portion of the furnace, thereby reducing temperature variation across the at least one substrate to less than 10 degrees Centigrade.

19. The method of claim 18 wherein the step of maintaining the first end cover and the second end cover at a lower temperature comprises maintaining both the first end cover and the second end cover substantially at room temperature to enhance convection within the furnace.
